(19) United States
(12) Patent Application Publication
(10) Pub. No.: US 2012/0241588 A1
(43) Pub. Date: Sep. 27, 2012

(54) SUPPORT FOR BLENDER BLADES

(76) Inventors: Rodrigo Dos Santos Rodrigues, Cidade Industrial (BR); Anderson Grossi Domingos, Sao Braz (BR)

(21) Appl. No.: 13/501,809

(22) PCT Filed: Aug. 15, 2010
(86) PCT No.: PCT/BR10/00350

§ 371 Date: Jun. 7, 2012

(30) Foreign Application Priority Data
Oct. 15, 2009 (BR) MU8902296-3

(51) Int. Cl. A47J 43/07

(52) U.S. Cl. 248/636

(57) ABSTRACT

A device used in home appliances like blenders, food processors and the like, commonly known as volcano (3) or support assembly (3) of the blades (1), equipped with an elastomeric bushing (2), which provides the support assembly (3) of the blades (1) and, consequently, to the household appliance, a quieter operation, increasing user comfort when using such appliances.

### FIELD OF THE INVENTION

This novelty belongs to the field of mechanical engineering, specifically for home appliances, exactly a support, conjugated to an elastomer, to condition the shaft of blender blades or similar products such as food processors, slicers and the alike.

### BACKGROUND OF THE INVENTION

Household appliances are electrical devices used to ease several household tasks, such as cooking and stowing food, cleaning the house, laundry, in the bathroom and in beauty care, and also as means of entertainment.

The blender is an electrical culinary tool that serves, roughly, to grind and mix a big variety of food, and also can drive them to liquefaction. It was invented in 1922 by Stephen Poplawski and it is basically formed by a base with an electrical motor which drives a small set of blades at the bottom of a recipient where the food is processed.

The current state of the art demonstrates a series blenders and food processors with different features, usually with the disadvantages of noise generated by vibration of the motor and the deficit coupling between its parts. The proposed innovation overcomes these problems by having a support for the blades, also known as ‘volcano’, and his adjuncts, carrying an annular bushing made of elastomeric material or other vibration and noise absorbent material coupled to the shaft of the blades and its adjuncts—whether bushings, mountings, bearings etc.—absorbing those vibrations deriving from the equipment operation, providing the household appliances with a more silent operation, delivering to the user an improved comfort with using it. Such phenomenon is magnified by the material elasticity, which allows a closer alignment between the engine transmission and the coupling of the blade assembly.

### ANALYSIS OF THE STATE OF THE ART

The patent PI9901626 describes a blade support system for household appliances like blenders, food processors or other devices of its kind, presenting an excellent seal and allowing also the removal of the support assembly of said blades allowing thorough cleaning of parts that compose the entire unit, as well as inside the appliance cup. It comprises a cup having a button embedded therein, a strap, a latch, spring portions incorporated to the strap and a clamp having locks in the edges; having ways of coupling between the button and the spring portions and the clamp; having ways to fix in a removable manner a blade assembly in such cup. Unlike the proposed solution, it does not present a vibration absorption system.

The document U.S. Pat. No. 5,584,577 shows a household blender that has blades attached to a shaft; the shaft being supported by a bushing-shaped bearing is provided with a seal to prevent the passage of liquids in an area between the blade shaft and the bearing. The seal is an annular member with a custom sized central opening to fit perpendicular around the blade shaft and with an inner flange inner sized to fit snugly around the outer surface of the bearing. Preferably the seal rotates with the shaft and slides along the bearing that can be attached to the non-circular cross section shaft, the seal having a complementary opening. The seal is preferably made of a plastic material lubricated to reduce friction and to adjust. It features a plastic material bushing, whose goal is a better sliding of the shaft, not having the vibration absorption feature.

The invention KR20020069705 reveals a blender comprising a base containing a motor; a mixing vessel containing a blade, a top housing between the base and the mixing vessel to cover the base and to support the mixing vessel, a clamp fixed installed in a rotatable manner in two certain positions of the top housing to compress the mixing vessel and a lid; and a rotating unit to rotate and to lift the handle, which is coupled to both sides of the upper housing with a bearing. Unlike the innovation presented, it does not feature the noise reduction.

### BRIEF DESCRIPTION OF THE INNOVATION

An innovation comes down to a device used in home appliances like blenders, food processors and the like, commonly known as volcano or support assembly of the blades, equipped with an elastomeric bushing, which provides the support assembly of the blades and, consequently, to the household appliance, with a quieter operation, increasing user comfort when using such appliances.

### RELATION OF FIGURES

FIG. 1 represents an exploded view of the generic component parts of the blades assembly (1) of a blender, highlighting the use of the support (3) for blades (1), carrying an annular bushing (2) of a vibration absorption material, the entire unit being handled by the connector (4) that effects the transmission of the motor movement to the assembly.

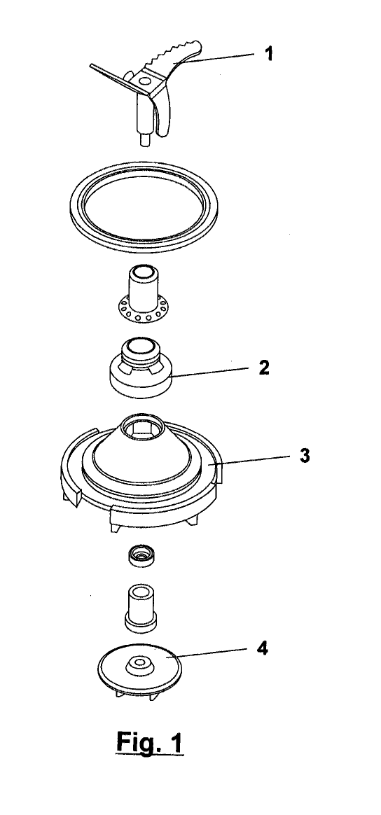

FIG. 2 demonstrates a cutway view of the volcano (3) assembled with an annular bushing (2), highlighting its interface position between the component parts of the equipment.

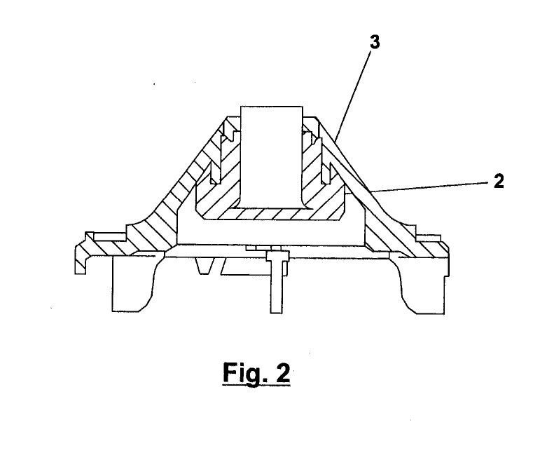

FIG. 3 reveals a perspective view of the support assembly coupling (3) of the blades (1) and the base (5) of the blender.

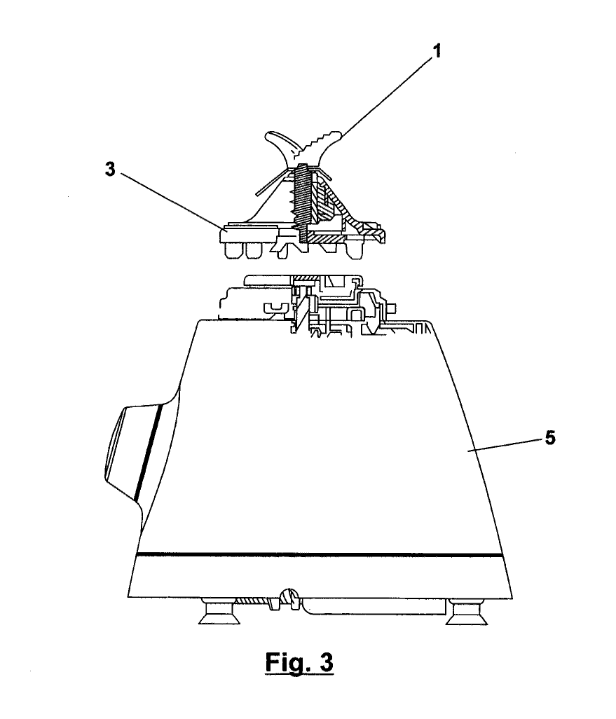

### DETAILED DESCRIPTION OF THE INNOVATION

This innovation describes a component used in household appliances like blenders, food processors and the alike, commonly known as volcano (3) or blades support assembly (1), which, in its preferred embodiment, is co-injected to an annular bushing (2) of an elastomeric material, staying intimately connected to the components of such assembly (3), for example, internal bushings. In an alternative embodiment, the material of such annular bushing (2) can be replaced by another non-elastomeric vibration absorbent material. Other embodiments can be presented as the solution with the simple coupling, crimp or fitting without the need for co-injection. In either case, the annular bushing (2) acts in order to absorb the vibrations of the volcano (3), during the operation of the equipment, caused, basically, by the motor rotation that drives the blades (1) through the connector (4) that effects the transmission of motion.

Said bushing (2) is intended to function as an interface between the fixed walls of the support assembly (3) and the coupling parts, such as the internal bushings. Its malleable nature allows the vibrations to be absorbed thereat, thus avoiding the impact to the rest of the equipment.

As a result, here we get a machine that works, significantly, quieter than similar ones found today in the state of the art.

This innovation is not limited to the representations mentioned or illustrated herein, and it has to be comprehended in its wide scope. Many changes and other representations of the present innovation will come in mind of those skilled in the art to which this innovation belongs, having the learning benefit presented in previous descriptions and attached drawings. Furthermore, it is to be understood that innovation is not limited to the specific form disclosed and that modifications and other forms are understood as included within the scope of the appended claims. Although specific terms are nominated herein, they are only used in a generic and descriptive form and not for a limiting purpose.

1. Household appliance, characterized by being provided with a bracket (3) equipped with bushing (2), preferably of annular shape, preferably made of elastomeric material, associated with other components of the support assembly (3) blades (1) preferably by co-injection, allocated in ways that provide the interface between the fixed walls of the support assembly (3) and the attachment parts, absorbing shocks between the rigid and thus mitigating the vibration of the set.

2. Support, according to claim 1, characterized by being supplied with a bush (2), made with a vibration absorbing material different from the elastomeric one.

3. Support, according to claim 1, characterized by being supplied with a bush (2) associated to other components of the support set (3) by a simple coupling, fitting or embedding.
